(19) United States
(12) Patent Application Publication
(10) Pub. No.: US 2008/0068066 A1
(43) Pub. Date: Mar. 20, 2008

(54) High efficiency white LED drivers

(75) Inventor: Rohit Mittal, Sunnyvale, CA (US)

Correspondence Address: Rohit Mittal, 1140 Blair Avenue, Sunnyvale, CA, 94087, US

(73) Assignee: NETASIC LLC

(21) Appl. No.: 11/901,160

(22) Filed: Sep. 14, 2007

Related U.S. Application Data
(60) Provisional application No. 60/845,111, filed on Sep. 18, 2006.

(51) Int. Cl. G05F 1/10

(52) U.S. Cl. 327/535

(57) ABSTRACT

A circuit device for a high efficiency current driver for a white LED is presented. The circuit device includes a bias transistor to provide a substantially constant bias current through a bias leg. A driver transistor is connected to the bias transistor and the current in the driver transistor substantially matches the bias current. A current feedback amplifier is configured in series with the driver transistor and a feedback node has a feedback voltage representative of an output voltage. A mirroring transistor connected to the feedback node mirrors the output voltage to the bias transistor thereby allowing the output current to substantially match the bias current when an applied voltage across the driver transistor is below a saturation voltage of the driver transistor thus mitigating effects of headroom limitation in the driver transistor.

### CROSS-REFERENCE TO RELATED APPLICATIONS

The present Utility patent application claims priority benefit of the U.S. provisional application for patent Ser. No. 60/845,111 filed on Sep. 9, 2006 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to the field of white LED drivers and in particular to circuit devices to improve the current regulation in them.

### BACKGROUND OF THE INVENTION

Many electronic devices such as, but not limited to, cell phones, PDAs, MP3 players, digital cameras, GPS receivers and handheld computing devices, incorporate LCD displays that require backlighting. Many of these LCD displays utilize white LEDs to provide this backlighting. Constant current devices are typically utilized to drive these LEDs. These devises provide a constant sink current through the LEDs to provide a constant desired luminance. These devices typically include an inductive converter or charge pump circuit to provide the current and a constant current regulator circuit.

Power conservation is a prime concern for battery-operated devices. It is desirable to maintain a maximum efficiency in the drivers of the LEDs.
For a charge pump based white LED driver, the efficiency is given by:
Efficiency=Vled/(Vin*mode),
Vled=Vout (output of charge pump)-voltage across the LED driver and Vin=voltage input to charge pump.

$$\begin{matrix}Where mode = 1 for straight \text{-} through \\ = 1.5 for fractional charge pump \\ = 2 for doubler\end{matrix}$$

Also For a charge pump based white LED driver,
Vout*Iout=Vin*In and Vout=mode*Vin

It is readily seen from the above equation that the efficiency will be higher if the charge pump remains in the 1x mode. This will also minimize the drain on the battery since the input and output currents are given by Iin=mode*Iout. A Charge pump is rated for Iout. Operating the charge pump in the mode 1 minimizes the input current drain from the battery. It is therefore desirable to have the charge pump operating in mode 1 for a maximum amount of time.

FIG. 1a is a circuit diagram illustrating an exemplary prior art current regulator and FIG. 1b is an exemplary prior art charge pump. In FIG. 1b, the charge pump 210 has an input, Vin 300 and an output, Vout 250. Vin is the voltage supplied from a battery supply, not shown. Referring to FIG. 1a, Vout 250 from charge pump 210 provides current to the anode of LED 301. Error amplifier 100 controls the voltage at the junction of resistor 105 and bias transistor 101 to be equal to Vref 107. The current flowing through resistor 105 and bias transistor 101 is thus fixed by the values of Vctrl 109, Vref 107 and resistor 105 where I=(Vctrl-Vref)/R. Since the gates of transistors 101 and 103 are connected, a current mirror is formed and as long as Vout is high enough to maintain saturation of driver transistor 103, the current flowing through LED 301 is equal to the current flowing through bias transistor 101.

In the typical operation of the charge pump 210 during startup, when the battery supply is charged, the charge pump operates in mode 1. As the battery supply discharges over time, Vin 300 and Vout 250 decrease at the same rate. At some point, Vout drops to a level where the current flowing through LED 301 cannot be maintained at the level of the current flowing through bias transistor 101. This occurs when driver transistor 103 goes into headroom limitation. Headroom limitation is defined as the drain-source voltage, Vds, at which the transistor is no longer in the saturation region. For a typical MOS transistor, Headroom limitation =>Vds <Vdsat where Vdsat is the drain-source voltage at saturation, typically Vdsat=200 mV. By this time the charge pump mode 210 is shifted to at least mode 1.5 and Vout 250 is boosted by 50% to maintain the current flow in LED 301. As shown in the equations above, the efficiency of the charge pump decreases and the current draw from the battery supply increases. As the battery supply continues to discharge, at a now faster rate due to the increased current draw, the charge pump will shift to mode 2 to maintain the current in the LED. In mode 2 Vout is boosted by 100% where the efficiency of the current pump further decreases and the current draw further increases until the battery supply can no longer maintain a sufficient Vin to maintain the current in the LED.

In view of the Foregoing, there is a need for a high efficiency LED driver that overcomes limitations of the prior art to maximize the time the current pump is in mode 1 and thus increase efficiency and extend the life of the battery supply.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1a is a circuit diagram illustrating an exemplary prior art current regulator and FIG. 1b is an exemplary prior art charge pump;

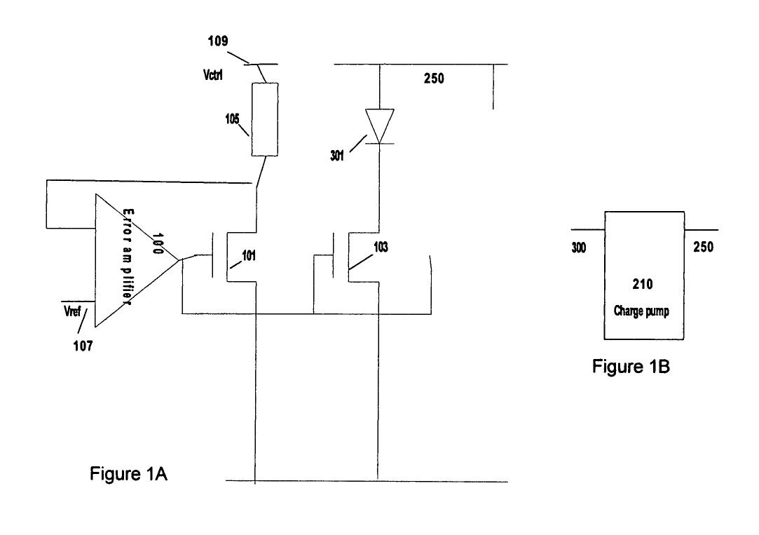

FIG. 2 illustrates a circuit diagram of an exemplary LED driver of one embodiment of the present invention;

FIG. 3 illustrates a circuit diagram of an exemplary LED driver of one embodiment of the present invention;

FIG. 4 illustrates a circuit diagram of an exemplary LED driver of one embodiment of the present invention for mitigating the effects of high Vds;

FIG. 5 illustrates a circuit diagram of an exemplary LED driver of one embodiment of the present invention where the circuit of FIG. 3 is implemented with pMOS transistors;

FIG. 6 illustrates a circuit diagram of an exemplary LED driver of one embodiment of the present invention where the circuit of FIG. 4 is implemented with pMOS transistors; and

FIG. 7 is a graph illustrating the bias and driver currents vs. drain voltage of an exemplary LED driver of one embodiment of the present invention.

### SUMMARY OF THE INVENTION

To achieve the forgoing and other objects and in accordance with the purpose of the invention, a high efficiency white LED driver is presented.

In one embodiment, a circuit device for a high efficiency current driver of at least one component is presented. The circuit device includes a bias transistor having a bias control input connected to a voltage node, the bias transistor being configured in a bias leg of the circuit device to provide a substantially constant bias current through the bias leg. A driver transistor having a driver control input and an output configured for driving a substantially constant output current through the at least one component connected to the output is configured in an output leg of the circuit device where the driver control input is connected to the bias control input and a total current in the driver transistor substantially matches the bias current. A current feedback amplifier having a feedback node is configured in the output leg in series with the driver transistor and connected to the output where a portion of the total current passes through the current feedback amplifier and the feedback node has a feedback voltage representative of an output voltage at the output. A mirroring transistor having a mirroring control input connected to the feedback node is configured in the bias leg in series with the bias transistor where the bias current passes through the mirroring transistor and the output voltage is mirrored to the bias transistor thereby allowing the output current to substantially match the bias current when an applied voltage across the driver transistor is below a saturation voltage of the driver transistor thus mitigating effects of headroom limitation in the driver transistor. Other embodiments further include at least one diode connected in series between the voltage node and the bias control thereby allowing the output current to substantially match the bias current when the applied voltage is at a high level and at least one feedback diode connected in series in a feedback path of the current feedback amplifier from an output leg voltage node in the output leg to the feedback node to provide symmetry between the bias and output legs. In a further embodiment, the driver transistor is further configured to provide the total current as a multiple N of the bias current. In further embodiments, the driver and bias transistors are further configured as MOS type transistors and the current feedback amplifier and the mirroring transistors are bipolar type transistors. In still another embodiment, the current feedback amplifier and the mirroring transistors are MOS type transistors. In another embodiment, the MOS type transistors are riMOS or pMOS. In yet another embodiment the at least one component is a white LED and the driver transistor is further configured to drive the LED at a constant current to produce a desired light output level.

In another embodiment, a circuit system for a high efficiency current driver of at least one component is presented. The circuit system includes means for providing a substantially constant bias current, means for driving a substantially constant output current through the at least one component connected to an output of the driving means where a total current in the driver means substantially matches the bias current, means for providing a current feedback amplifier where the amplifier means has a feedback voltage representative of an output voltage at the output and means for mirroring the output voltage the bias current means thereby allowing the output current to substantially match the bias current by mitigating effects of headroom limitation in the driver means. Another embodiment further includes means for allowing the output current to substantially match the bias current when an applied voltage on the driver means is at a high level.

In another embodiment, an integrated circuit, IC, device for a high efficiency current driver of at least one component is presented. The IC device includes an IC package suitable for mounting on and connecting to a circuit board, the package enclosing a circuit device including a bias transistor having a bias control input connected to a voltage node, the bias transistor being configured in a bias leg of the circuit device to provide a substantially constant bias current through the bias leg. A driver transistor having a driver control input and an output configured for driving a substantially constant output current through the at least one component connected to the output is configured in an output leg of the circuit device where the driver control input is connected to the bias control input and a total current in the driver transistor substantially matches the bias current. A current feedback amplifier including a feedback node configured in the output leg in series with the driver transistor and connected to the output where a portion of the total current passes through the current feedback amplifier and the feedback node has a feedback voltage representative of an output voltage at the output. A mirroring transistor having a mirroring control input connected to the feedback node, is configured in the bias leg in series with the bias transistor where the bias current passes through the mirroring transistor and the output voltage is mirrored to the bias transistor thereby allowing the output current to substantially match the bias current when an applied voltage across the driver transistor is below a saturation voltage of the driver transistor thus mitigating effects of headroom limitation in the driver transistor.

Other embodiments further include at least one diode connected in series between the voltage node and the bias control thereby allowing the output current to substantially match the bias current when the applied voltage is at a high level and at least one feedback diode connected in series in a feedback path of the current feedback amplifier from an output leg voltage node in the output leg to the feedback node to provide symmetry between the bias and output legs. In another embodiment the driver transistor is further configured to provide the total current as a multiple N of the bias current. In yet other embodiments, the driver and bias transistors are further configured as MOS type transistors, the current feedback amplifier and the mirroring transistors are bipolar type transistors. In other embodiments the current feedback amplifier and the mirroring transistors are MOS type transistors and the MOS type transistors are nMOS or pMOS.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

An aspect of preferred embodiments of the present invention is to provide matched currents in the bias and LED driver transistors even when the voltage across the bias and LED driver transistors is lower than the saturation voltage and regulation that works in the linear region as well. This allows a charge pump to operate in the most efficient modes for a longer period of time and extend the useful life of a battery supply. In some embodiments, a current feedback amplifier is utilized at the output of the LED driver transistors to hold the drain voltages of the bias and driver transistors substantially constant for a wide range of conditions. Furthermore, the current feedback amplifier is configured such that the addition of the amplifier consumes no additional current.

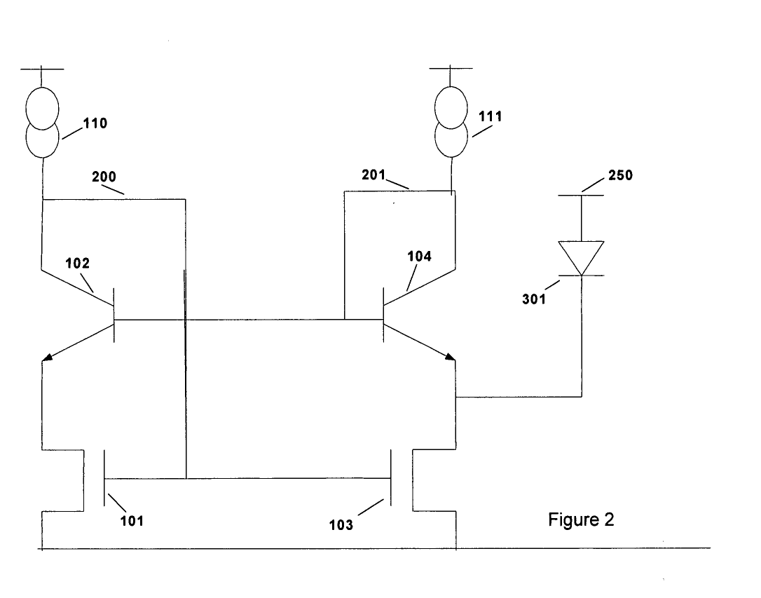

FIG. 2 illustrates a circuit diagram of an exemplary LED driver of one embodiment of the present invention. Driver transistor 103 is the main LED 301 driver. Bias transistor 101 sets the bias voltage for driver transistor 103. In this embodiment, driver transistor 103 is constructed to provide a multiple, N, of the current in bias transistor 101 for a given gate voltage, I(103)=N*I(101). One skilled in the art will realize that N, and as such the size of driver transistor 103, should be chosen by considering various factors such as, but not limited to, minimum bias current in bias transistor 101 and desired current to drive one or more LEDs. Bipolar transistors 102 and 104 are configured to maintain the drain-source voltages of transistor 101 and 103 the same. Transistor 104 is configured as a current feedback amplifier at the output of the driver transistor 103. In this embodiment, current sources 110 and 111 are configured to provide equal currents. In other embodiments, the currents may not be equal when evaluating factors such as, but not limited to, the value of N. As shown in the diagram, the Vds of driver transistor 103=voltage at node 250−voltage drop of forward biased LED 301. Transistors 102 and 104 mirror this voltage to bias transistor 101. Since current sources 110 and 111 are the same, the base emitter voltages of transistors 102 and 104 are the same. Therefore, the Vds voltages and the gate voltages of transistors 101 and 103 will be the same. This allows the current in transistor 103 to match the current in transistor 101 by the factor of N down to a very low Vds voltage on the order of 20 mV. In comparison, if transistors 102 and 104 were not included, as in the prior art, the driver transistor 103 would go into headroom limitation when the Vds of the driver transistor is at about 200 mv and the current in driver transistor would not match the current in the bias transistor 101. In the preferred embodiment of the invention, the prior art headroom limitation is overcome and the charge pump is allowed to operate in the most efficient modes for a longer period of time thus extending the useful life of the battery supply. This circuit is ideally suited for a BiCMOS or BCD process.

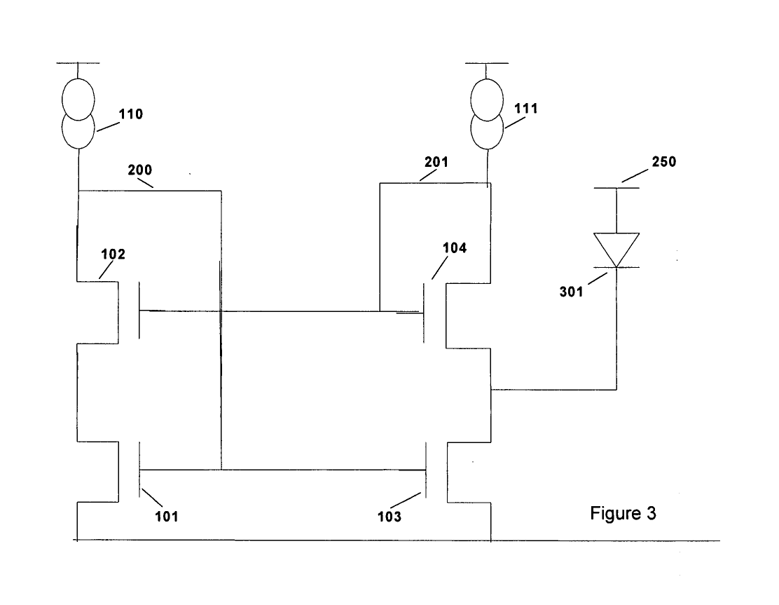

FIG. 3 illustrates a circuit diagram of an exemplary LED driver of one embodiment of the present invention. This embodiment is similar to the embodiment of FIG. 2. In FIG. 3 the bipolar transistors 102 and 104 of FIG. 2 are replaced with NMOS transistors. Driver transistor 103 is the main LED 301 driver. Bias transistor 101 sets the bias voltage for driver transistor 103. In this embodiment, driver transistor 103 is constructed to provide a multiple, N, of the current in bias transistor 101 for a given gate voltage, I(103)=N*I(101). Current sources 110 and 111 are configured to provide equal currents. In other embodiments, the currents may not be equal. As shown in the diagram, the Vds of driver transistor 103=voltage at node 250−voltage drop of forward biased LED 301. Transistors 102 and 104, with transistor 104 configured as a current feedback amplifier, mirror this voltage to bias transistor 101. Therefore, the Vds and the gate voltages of transistors 101 and 103 will be the same. This allows the current in transistor 103 to match the current in transistor 101 by the factor of N down to a very low Vds on the order of 20 mV before a mode switch in the charge pump has to occur. In the present embodiment of the invention, the prior art headroom limitation is overcome and the charge pump is allowed to operate in the most efficient modes for a longer period of time thus extending the useful life of the battery supply.

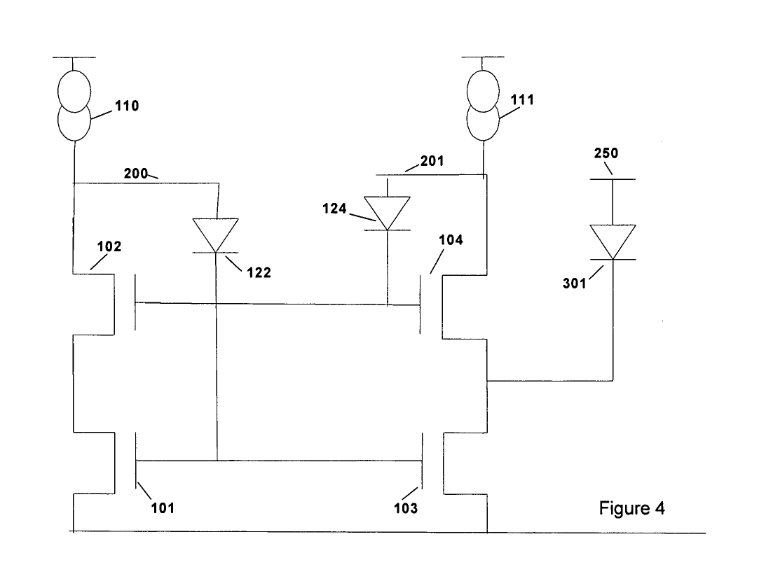

FIG. 4 illustrates a circuit diagram of an exemplary LED driver of one embodiment of the present invention for mitigating the effects of high Vds voltage at the drain of transistor 103. A typical high value of Vds is approximately 4V in a 5V process. In FIG. 3, as the Vds on transistor 103 increases, the node 201 also increases. This increases the voltage on the drain of transistor 101, ie source of transistor 102. However, the current going through transistor 101 fixes node 200. Hence, the net effect is to constrict the Vds of transistor 102. Therefore, both transistors 102 and 101 go into linear operating region, causing a mismatch between the currents in transistors 101 and 103. In FIG. 4, diode 122 is added between node 200 and the gates of transistors 101 and 103. This ensures that node 200 goes high and doesn't limit the Vds of transistor 101. This allows the Vds of transistor 101 to rise and still maintain transistor 102 in the correct mode of operation. Diode 124 is added to ensure symmetry between the two matching legs by providing a voltage drop between node 201 and gates of transistors 102 and 104. In the present embodiment of the invention, the prior art headroom limitation is overcome and the effects of high Vds are mitigated. The charge pump is allowed to operate in the most efficient modes for a longer period of time thus extending the useful life of the battery supply. In other embodiments, switches in parallel with 122 and 124 (not shown) can be added to switch off these diodes during times when the Vds of driver transistor 103 is low. In a typical application, for example, but without limitation, this occurs from 500 mV to 20 mV, though this range can vary significantly with change in process technology or functionality of the circuit. This switch can be implemented such as, but not limited to, a MOS transistor, bipolar transistor or a relay. In other embodiments, a bias current circuit (not shown) provides current through diodes 122 and 124 to forward bias the diodes to ensure sufficient voltage across both. In further embodiments requiring higher Vds, additional diodes can be put in series with 122 and 124. This occurs in applications running at higher supply voltages. For example, but not limited to, if the supply voltage is close to 10V and 1 or more LEDs are stacked in series between Vout and Vled, there may be need to have multiple diodes in series with 122 and 124.

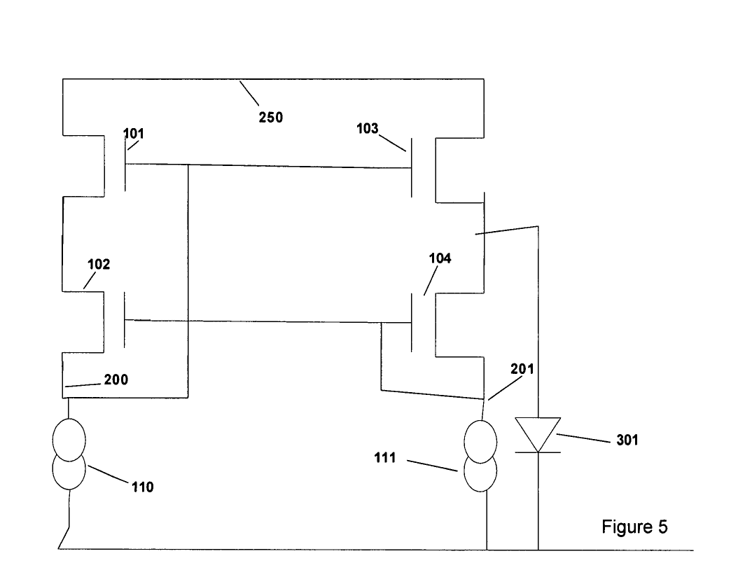

FIG. 5 illustrates a circuit diagram of an exemplary LED driver of one embodiment of the present invention where the circuit of FIG. 3 is implemented with pMOS transistors. In this embodiment, the driver transistor 103 drives the LED 301 anode. Elements 110 and 111 are current sinks. Bias transistor 101 sets the bias voltage for driver transistor 103. In this embodiment, driver transistor 103 is constructed to provide a multiple, N, of the current in bias transistor 101 for a given gate voltage, I(103)=N*I(101). Current sinks 110 and 111 are configured to sink equal currents. In other embodiments, the currents may not be equal. As shown in the diagram, the Vds of driver transistor 103=voltage at node 250−voltage drop of forward biased LED 301. Transistor 102 and 104 mirror this voltage to bias transistor 101. Transistor 104 is configured as a current feedback amplifier. Therefore, the Vds and the gate voltages of transistors 101 and 103 will be the same. This allows the current in transistor 103 to match the current in transistor 101 by the factor of N down to a very low Vds on the order of 20 mV before a mode switch in charge pump has to occur. In the present embodiment of the invention, the prior art headroom limitation is overcome and the charge pump is allowed to operate in the most efficient modes for a longer period of time thus extending the useful life of the battery supply.

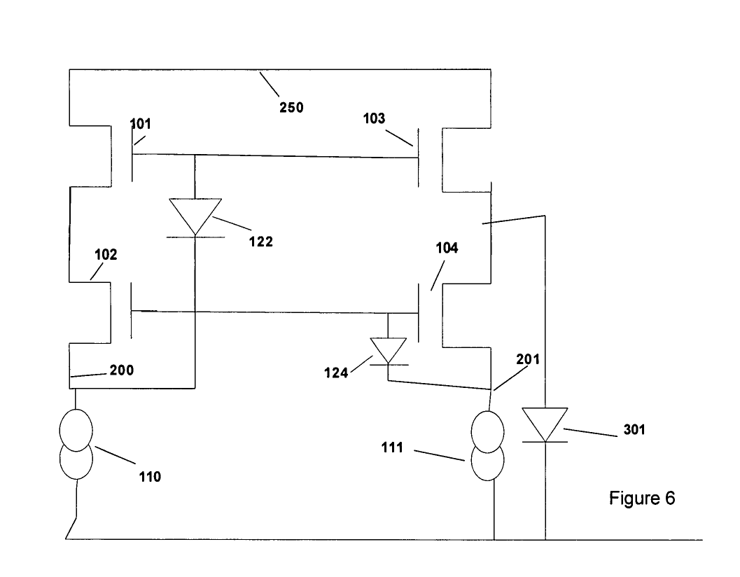

FIG. 6 illustrates a circuit diagram of an exemplary LED driver of one embodiment of the present invention where the circuit of FIG. 4 is implemented with pMOS transistors. In FIG. 4, as the Vds on transistor 103 increases, the voltage on node 201 also increases. This increases the voltage on the drain of transistor 101, ie source of transistor 102. However, the current going through transistor 101 fixes node 200. Hence, the net effect is to constrict the Vds of transistor 102. Therefore both transistors 102 and 101 go into linear operating region, causing a mismatch between the currents in transistors 101 and 103. In this embodiment, the driver transistor 103 drives the LED 301 anode. Elements 110 and 111 are current sinks. Diode 122 is added between node 200 and the gates of transistors 101 and 103. This ensures that node 200 doesn't limit the Vds of transistor 101. This allows the Vds of transistor 101 to rise and still maintain transistor 102 in the correct mode of operation. Diode 124 is added to ensure symmetry between the two matching legs by providing a voltage drop between node 201 and gates of transistors 102 and 104. In other embodiments, switches in parallel with 122 and 124 (not shown) can be added to switch off these diodes during times when the Vds of driver transistor 103 is low. This switch can be implemented such as, but not limited to, a MOS transistor, bipolar transistor or a relay. In other embodiments, a bias current circuit (not shown) provides current through diodes 122 and 124 to ensure sufficient voltage across both. In further embodiments requiring higher Vds, additional diodes can be put in series with 122 and 124.

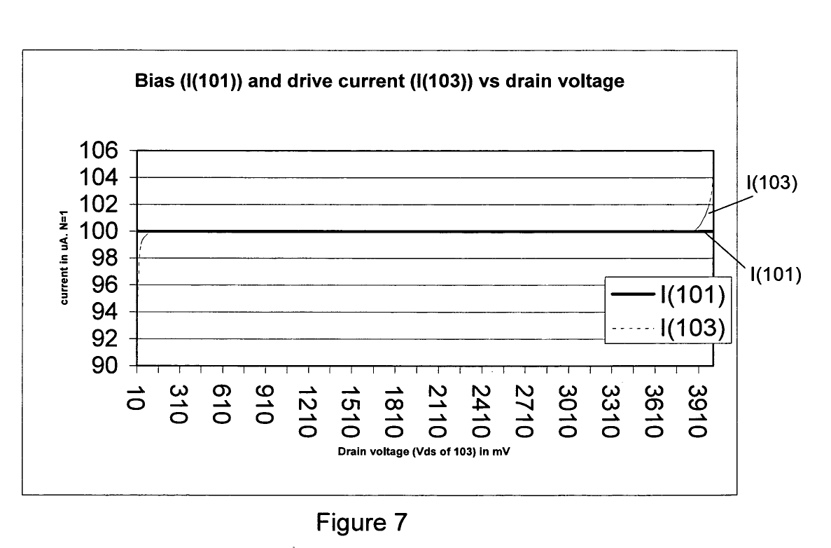

FIG. 7 is a graph illustrating the bias and driver currents vs. drain voltage of an exemplary LED driver of one embodiment of the present invention. In this embodiment the bias current in transistor 101 and the drive current in transistor 103 are equal, N=1. From the graph it can be observed that the currents in transistors 103 and 101 match each other precisely down to a Vds of 100 mv and a 2 ua difference at 20 mv. At high Vds, the currents match until about 3.9 volts. If diodes 122 and 124 are added, as shown in the embodiments in FIGS. 4 and 6, then the currents in transistors 101 and 103 could be made to match to higher voltage levels.

In other embodiments, the present invention may be used with other current sources other than charge pumps such as, but not limited to, an inductive converter, linear drop-out regulators, LDOs, flash and high brightness white LED drivers. In some embodiments of the present invention, multiple LEDs may be driven at the same time. For example, without limitation, multiple LEDs could be in series connection, parallel connection, or multiple driver transistors could be provided.

In other embodiments, the present invention may be used to drive any type of LED emitting in the visible or invisible light spectrum. In yet other embodiments, the present invention may be used with other circuits for setting or controlling the level of the current in the LED such as, but not limited to, a programmable input for setting a desired luminance level or a circuit for adjusting the luminance relative to the ambient light levels.

In other embodiments, the present invention maybe used in general purpose analog products such as, but not limited to, rail-to-rail opamps or variable gain amplifiers, VGA. Such products require a large signal swing at the output to ensure a high signal to noise ratio at the output. By reducing the voltage “wasted” to keep constant current, more of the available power supply voltage can be used to drive the output connections.

In other embodiments, the present invention maybe used in analog to digital interfaces such as, but not limited to, current steering digital to analog converters, DACs. The output current can be kept constant over a wider range of output voltage levels, allowing the system designer a higher dynamic range to utilize.

In other embodiments, the present invention can be used in high frequency interface circuits such as, but not limited to, transmitters for RS-232 and Ethernet. To compensate for attenuation over long distances of cable, a larger signal level at the transmitter is desired. By limiting the voltage drop across the current supplying transistors, more of the signal is supplied across the cable, thus allowing the design to reach longer distances.

Having fully described at least one embodiment of the present invention, other equivalent or alternative methods of implementing high efficiency white LED drivers according to the present invention will be apparent to those skilled in the art. The invention has been described above by way of illustration, and the specific embodiments disclosed are not intended to limit the invention to the particular forms disclosed. For example, without limitation, the embodiments described in the foregoing were directed to MOS and bipolar transistors but other similarly operating device are also contemplated as utilized with the present invention. Furthermore, embodiments of the present invention were directed to driving LEDs emitting in the visible light spectrum but the application of the invention to other emitting devices requiring a similar control is anticipated. The invention is thus to cover all modifications, equivalents, and alternatives falling within the spirit and scope of the following claims.

What is claimed is:

1. A circuit device for a high efficiency current driver of at least one component, the circuit device comprising:
a bias transistor comprising a bias control input connected to a voltage node, said bias transistor being configured in a bias leg of the circuit device to provide a substantially constant bias current through said bias leg;
a driver transistor comprising a driver control input and an output configured for driving a substantially constant output current through the at least one component connected to said output, said driver transistor configured in an output leg of the circuit device where said driver control input is connected to said bias control input and a total current in said driver transistor substantially matches said bias current;
a current feedback amplifier comprising a feedback node, said current feedback amplifier configured in said output leg in series with said driver transistor and connected to said output where a portion of said total current passes through said current feedback amplifier and said feedback node has a feedback voltage representative of an output voltage at said output; and
a mirroring transistor comprising a mirroring control input connected to said feedback node, said mirroring transistor configured in said bias leg in series with said bias transistor where said bias current passes through said mirroring transistor and said output voltage is mirrored to said bias transistor thereby allowing said output current to substantially match said bias current when an applied voltage across said driver transistor is below a saturation voltage of said driver transistor thus mitigating effects of headroom limitation in said driver transistor.

2. The circuit device as recited in claim 1, further comprising at least one diode connected in series between said voltage node and said bias control thereby allowing said output current to substantially match said bias current when said applied voltage is at a high level.

3. The circuit device as recited in claim 2, further comprising at least one feedback diode connected in series in a feedback path of said current feedback amplifier from an output leg voltage node in said output leg to said feedback node to provide symmetry between said bias and output legs.

4. The circuit device as recited in claim 1, wherein said driver transistor is further configured to provide said total current as a multiple N of said bias current.

5. The circuit device as recited in claim 1, wherein said driver and bias transistors are further configured as MOS type transistors.

6. The circuit device as recited in claim 5, wherein said current feedback amplifier and said mirroring transistors are bipolar type transistors.

7. The circuit device as recited in claim 5, wherein said current feedback amplifier and said mirroring transistors are MOS type transistors.

8. The circuit device as recited in claim 7, wherein said MOS type transistors are nMOS or pMOS.

9. The circuit device as recited in claim 1, wherein the at least one component is a white LED and said driver transistor is further configured to drive the LED at a constant current to produce a desired light output level.

10. A circuit system for a high efficiency current driver of at least one component, the circuit system comprising:
means for providing a substantially constant bias current;
means for driving a substantially constant output current through the at least one component connected to an output of said driving means where a total current in said driver means substantially matches said bias current;
means for providing a current feedback amplifier where said amplifier means has a feedback voltage representative of an output voltage at said output; and
means for mirroring said output voltage said bias current means thereby allowing said output current to substantially match said bias current by mitigating effects of headroom limitation in said driver means.

11. The circuit system as recited in claim 10, further comprising means for allowing said output current to substantially match said bias current when an applied voltage on said driver means is at a high level.

12. An integrated circuit, IC, device for a high efficiency current driver of at least one component, the IC device comprising:
an IC package suitable for mounting on and connecting to a circuit board, said package enclosing a circuit device comprising:
a bias transistor comprising a bias control input connected to a voltage node, said bias transistor being configured in a bias leg of the circuit device to provide a substantially constant bias current through said bias leg;
a driver transistor comprising a driver control input and an output configured for driving a substantially constant output current through the at least one component connected to said output, said driver transistor configured in an output leg of the circuit device where said driver control input is connected to said bias control input and a total current in said driver transistor substantially matches said bias current;
a current feedback amplifier comprising a feedback node, said current feedback amplifier configured in said output leg in series with said driver transistor and connected to said output where a portion of said total current passes through said current feedback amplifier and said feedback node has a feedback voltage representative of an output voltage at said output; and
a mirroring transistor comprising a mirroring control input connected to said feedback node, said mirroring transistor configured in said bias leg in series with said bias transistor where said bias current passes through said mirroring transistor and said output voltage is mirrored to said bias transistor thereby allowing said output current to substantially match said bias current when an applied voltage across said driver transistor is below a saturation voltage of said driver transistor thus mitigating effects of headroom limitation in said driver transistor.

13. The IC device as recited in claim 12, further comprising at least one diode connected in series between said voltage node and said bias control thereby allowing said output current to substantially match said bias current when said applied voltage is at a high level.

14. The IC device as recited in claim 13, further comprising at least one feedback diode connected in series in a feedback path of said current feedback amplifier from an output leg voltage node in said output leg to said feedback node to provide symmetry between said bias and output legs.

15. The IC device as recited in claim 12, wherein said driver transistor is further configured to provide said total current as a multiple N of said bias current.

16. The IC device as recited in claim 12, wherein said driver and bias transistors are further configured as MOS type transistors.

17. The IC device as recited in claim 16, wherein said current feedback amplifier and said mirroring transistors are bipolar type transistors.

18. The IC device as recited in claim 17, wherein said circuit device is produced by a BiCMOS or BCD process.

19. The IC device as recited in claim 16, wherein said current feedback amplifier and said mirroring transistors are MOS type transistors.

20. The IC device as recited in claim 19, wherein said MOS type transistors are nMOS or pMOS.
